(19) United States
(12) Patent Application Publication
(10) Pub. No.: US 2015/0371643 A1
(43) Pub. Date: Dec. 24, 2015

(54) STEREO AUDIO SIGNAL ENCODER

(71) Applicants: Anssi Ramo, Tampere (FI); Adriana Vasilache, Tampere (FI); Lasse Laaksonen, Nokia (FI); Miikka Vilermo, Siuro (FI); Mikko Tammi, Tampere (FI)

(72) Inventors: Anssi Ramo, Tampere (FI); Adriana Vasilache, Tampere (FI); Lasse Laaksonen, Nokia (FI); Miikka Vilermo, Siuro (FI); Mikko Tammi, Tampere (FI)

(73) Assignee: Nokia Corporation, Espoo (FI)

(21) Appl. No.: 14/394,211

(22) PCT Filed: Apr. 18, 2012
(86) PCT No.: PCT/IB2012/051943

§ 371 Date: Dec. 28, 2014

(51) Int. Cl. G10L 19/008; H04S 1/00

(52) U.S. Cl. CPC G10L 19/008; H04S 1/007; H04S 2420/03

(57) ABSTRACT

An apparatus comprising a channel analyser configured to analyse an audio signal comprising at least two audio channels to determine at least one parameter associated with a difference between the at least two audio channels; an encoding mode determiner configured to select a multichannel audio signal encoding dependent on the at least one parameter; and a channel encoder configured to encode the audio signal with the multichannel audio signal encoding.

### FIELD

The present application relates to a stereo audio signal encoder, and in particular, but not exclusively to a stereo audio signal encoder for use in portable apparatus.

### BACKGROUND

Audio signals, like speech or music, are encoded for example to enable efficient transmission or storage of the audio signals.

Audio encoders and decoders (also known as codecs) are used to represent audio based signals, such as music and ambient sounds (which in speech coding terms can be called background noise). These types of coders typically do not utilise a speech model for the coding process, rather they use processes for representing all types of audio signals, including speech. Speech encoders and decoders (codecs) can be considered to be audio codecs which are optimised for speech signals, and can operate at either a fixed or variable bit rate.

An audio codec can also be configured to operate with varying bit rates. At lower bit rates, such an audio codec may be optimized to work with speech signals at a coding rate equivalent to a pure speech codec. At higher bit rates, the audio codec may code any signal including music, background noise and speech, with higher quality and performance. A variable-rate audio codec can also implement an embedded scalable coding structure and bitstream, where additional bits (a specific amount of bits is often referred to as a layer) improve the coding upon lower rates, and where the bitstream of a higher rate may be truncated to obtain the bitstream of a lower rate coding. Such an audio codec may utilize a codec designed purely for speech signals as the core layer or lowest bit rate coding.

An audio codec is designed to maintain a high (perceptual) quality while improving the compression ratio. Thus instead of waveform matching coding it is common to employ various parametric schemes to lower the bit rate. For multichannel audio, such as stereo signals, it is common to use a larger amount of the available bit rate on a mono channel representation and encode the stereo or multichannel information exploiting a parametric approach which uses relatively fewer bits.

Real life multichannel signal types which can be used include binaural stereo and near-far stereo representation. Binaural stereo refers to a stereo signal typically obtained through recording sound with two microphones arranged with the intent to create a natural three dimensional stereo or spatial sound sensation for the listener. Such microphone arrangements typically include a dummy head, with microphones in the dummy head ears, placing a microphone near each ear of a real person, or even placing two microphones at a typical distance of a person's ears from each other (usually such that direct sound between the two microphones is blocked). Near-far stereo on the other hand refers to a stereo compatible stereo signal typically obtained through recording sound with two microphones arranged such that one microphone is close to the primary sound source, for example a person's mouth, and the other microphone is slightly further away (for example close to a person's ear if a regular mobile phone form factor is used) and concentrating more on recording the ambient sound. In such circumstances the near channel can be directly used as the mono input signal.

On playback using headphones the perception of a binaural stereo recording is generally such that the person listening feels as if they are in the recording environment themselves. The near-far stereo representation on the other hand may be played back such that one ear receives the near channel while the other ear receives the far channel audio information. Thus the experience is similar to a traditional monaural phone call hearing the talker in one ear and hearing the ambient sound of the recording environment instead of their own environmental ambient sounds through the other ear. Both real life stereo signal types can therefore be considered as representations that provides the listener with a natural and enjoyable feeling of the recording environment.

### SUMMARY

There is provided according to a first aspect a method comprising: analysing an audio signal comprising at least two audio channels to determine at least one parameter associated with a difference between the at least two audio channels; selecting a multichannel audio signal encoding dependent on the at least one parameter; and encoding the audio signal with the multichannel audio signal encoding.

Analysing an audio signal comprising at least two audio channels to determine at least one parameter associated with a difference between the at least two audio channels may comprise: generating a frequency domain representation for the at least two audio channels of the audio signal; separating the frequency domain representation for the at least two audio channels of the audio signal into at least two frequency bands; and generating at least one parameter associated with the difference between two audio channels for a frequency band.

The parameter may comprise at least one of: a relative energy signal level associated with the at least two audio channels; a correlation value associated with the at least two audio channels; and a time shift value associated with the at least two audio channels.

Selecting a multichannel audio signal encoding dependent on the at least one parameter may comprise: selecting an initial default multichannel audio signal encoding; selecting a second audio signal multichannel audio signal encoding dependent on a first selection of the at least one parameter; and maintaining the second audio signal multichannel audio signal encoding dependent on a second selection of the at least one parameter.

The first selection of the at least one parameter may be a combination of a relative energy signal level and a correlation value associated with the at least two audio channels, and wherein selecting the second audio signal multichannel audio signal encoding dependent on a first selection of the at least one parameter may comprise selecting the second audio signal multichannel audio signal encoding where the combination is greater than a determined threshold value.

The second selection of the at least one parameter may be a relative energy signal level associated with the at least two audio channels, and wherein maintaining the second audio signal multichannel audio signal encoding may comprise maintaining the second audio signal multichannel audio signal encoding where the relative energy signal level is less than a second determined threshold value.

The multichannel audio signal encoding may comprise at least one of: binaural encoding; and near-far stereo encoding.

Encoding the audio signal with the multichannel audio signal encoding may comprise: combining the at least two audio channels to form a single combined channel audio signal; encoding the single combined channel audio signal; and generating data associated with the at least two audio channels using the multichannel audio signal encoding such that the data enables the at least two audio channels to be reproduced from the single combined channel audio signal.

According to a second aspect there is provided a method comprising: receiving an encoded audio signal; selecting a multichannel audio signal decoding dependent on a first part of the encoded audio signal; and decoding a second part of the encoded audio signal, the second part of the audio signal encoded with a multichannel audio signal encoding, such that the decoding the second part of the encoded audio signal generates an audio signal comprising at least two audio channels.

Decoding a second part of the encoded audio signal may comprise: generating a first channel audio signal from a first section of the second part of the encoded audio signal; and generating at least one further channel audio signal from a second section of the second part of the encoded audio signal dependent on the multichannel audio signal decoding indicated by the first part of the encoded audio signal.

The first channel may be a left channel audio signal and the at least one further channel audio signal may be a right channel audio signal.

The first channel may be a combined channel audio signal and the at least one further channel audio signal may comprise a left channel signal and a right channel audio signal.

According to a third aspect there is provided a method comprising: determining at least one channel pair distance value for an audio signal comprising at least a pair of audio channels; encoding the audio signal with a multichannel audio signal encoding to generate at least an encoded signal and difference signal; and generating an equivalent difference signal dependent on the difference signal, the at least one channel pair distance value and an encoded channel distance value.

The method may further comprise receiving the encoded channel distance value.

Receiving the encoded channel distance value may comprise at least one of: determining an encoded channel distance value from a user input; and receiving an encoded channel distance value from a decoder.

The method may comprise receiving the audio signal from a pair of microphones, wherein a first audio channel may be from a first microphone and a second audio channel may be from a second microphone, wherein determining the at least one channel pair distance value may comprise determining the distance between the first microphone and the second microphone.

According to a fourth aspect there is provided a method comprising: receiving an encoded signal and an equivalent difference signal; reproducing a pair of audio channels with a determined channel distance dependent on the encoded signal and the equivalent difference signal.

The method may further comprise: determining an encoded channel distance value; and generating a pair of audio channels with a desired channel distance dependent on the encoded signal, the equivalent difference signal, the encoded channel distance value and the desired channel distance.

According to a fifth aspect there is provided an apparatus comprising at least one processor and at least one memory including computer program code for one or more programs, the at least one memory and the computer program code configured to, with the at least one processor, cause the apparatus at least to perform: analysing an audio signal comprising at least two audio channels to determine at least one parameter associated with a difference between the at least two audio channels; selecting a multichannel audio signal encoding dependent on the at least one parameter; and encoding the audio signal with the multichannel audio signal encoding.

Analysing an audio signal comprising at least two audio channels to determine at least one parameter associated with a difference between the at least two audio channels may cause the apparatus to perform: generating a frequency domain representation for the at least two audio channels of the audio signal; separating the frequency domain representation for the at least two audio channels of the audio signal into at least two frequency bands; and generating at least one parameter associated with the difference between two audio channels for a frequency band.

The parameter may comprise at least one of: a relative energy signal level associated with the at least two audio channels; a correlation value associated with the at least two audio channels; and a time shift value associated with the at least two audio channels.

Selecting a multichannel audio signal encoding dependent on the at least one parameter may cause the apparatus to perform: selecting an initial default multichannel audio signal encoding; selecting a second audio signal multichannel audio signal encoding dependent on a first selection of the at least one parameter; and maintaining the second audio signal multichannel audio signal encoding dependent on a second selection of the at least one parameter.

The first selection of the at least one parameter may be a combination of a relative energy signal level and a correlation value associated with the at least two audio channels, and wherein selecting the second audio signal multichannel audio signal encoding dependent on a first selection of the at least one parameter may cause the apparatus to perform selecting the second audio signal multichannel audio signal encoding where the combination is greater than a determined threshold value.

The second selection of the at least one parameter may be a relative energy signal level associated with the at least two audio channels, and wherein maintaining the second audio signal multichannel audio signal encoding may cause the apparatus to perform maintaining the second audio signal multichannel audio signal encoding where the relative energy signal level is less than a second determined threshold value.

The multichannel audio signal encoding may comprise at least one of: binaural encoding; and near-far stereo encoding.

Encoding the audio signal with the multichannel audio signal encoding may cause the apparatus to perform: combining the at least two audio channels to form a single combined channel audio signal; encoding the single combined channel audio signal; and generating data associated with the at least two audio channels using the multichannel audio signal encoding such that the data enables the at least two audio channels to be reproduced from the single combined channel audio signal.

According to a sixth aspect there is provided an apparatus comprising at least one processor and at least one memory including computer program code for one or more programs, the at least one memory and the computer program code configured to, with the at least one processor, cause the apparatus at least to perform: receiving an encoded audio signal; selecting a multichannel audio signal decoding dependent on a first part of the encoded audio signal; and decoding a second part of the encoded audio signal, the second part of the audio signal encoded with a multichannel audio signal encoding, such that the decoding the second part of the encoded audio signal generates an audio signal comprising at least two audio channels.

Decoding a second part of the encoded audio signal may cause the apparatus to perform: generating a first channel audio signal from a first section of the second part of the encoded audio signal; and generating at least one further channel audio signal from a second section of the second part of the encoded audio signal dependent on the multichannel audio signal decoding indicated by the first part of the encoded audio signal.

The first channel may be a left channel audio signal and the at least one further channel audio signal may be a right channel audio signal.

The first channel may be a combined channel audio signal and the at least one further channel audio signal may comprise a left channel signal and a right channel audio signal.

According to a seventh aspect there is provided an apparatus comprising at least one processor and at least one memory including computer program code for one or more programs, the at least one memory and the computer program code configured to, with the at least one processor, cause the apparatus at least to perform: determining at least one channel pair distance value for an audio signal comprising at least a pair of audio channels; encoding the audio signal with a multichannel audio signal encoding to generate at least an encoded signal and difference signal; and generating an equivalent difference signal dependent on the difference signal, the at least one channel pair distance value and an encoded channel distance value.

The apparatus may further be caused to perform receiving the encoded channel distance value.

Receiving the encoded channel distance value may cause the apparatus to perform at least one of: determining an encoded channel distance value from a user input; and receiving an encoded channel distance value from a decoder.

The apparatus may be caused to perform receiving the audio signal from a pair of microphones, wherein a first audio channel may be from a first microphone and a second audio channel may be from a second microphone, wherein determining the at least one channel pair distance value may cause the apparatus to perform determining the distance between the first microphone and the second microphone.

According to an eighth aspect there is provided an apparatus comprising at least one processor and at least one memory including computer program code for one or more programs, the at least one memory and the computer program code configured to, with the at least one processor, cause the apparatus at least to perform: receiving an encoded signal and an equivalent difference signal; and reproducing a pair of audio channels with a determined channel distance dependent on the encoded signal and the equivalent difference signal.

The apparatus may be caused to perform: determining an encoded channel distance value; and generating a pair of audio channels with a desired channel distance dependent on the encoded signal, the equivalent difference signal, the encoded channel distance value and the desired channel distance.

According to a ninth aspect there is provided an apparatus comprising: means for analysing an audio signal comprising at least two audio channels to determine at least one parameter associated with a difference between the at least two audio channels; means for selecting a multichannel audio signal encoding dependent on the at least one parameter; and means for encoding the audio signal with the multichannel audio signal encoding.

The means for analysing an audio signal comprising at least two audio channels to determine at least one parameter associated with a difference between the at least two audio channels may comprise: means for generating a frequency domain representation for the at least two audio channels of the audio signal; means for separating the frequency domain representation for the at least two audio channels of the audio signal into at least two frequency bands; and means for generating at least one parameter associated with the difference between two audio channels for a frequency band.

The parameter may comprise at least one of: a relative energy signal level associated with the at least two audio channels; a correlation value associated with the at least two audio channels; and a time shift value associated with the at least two audio channels.

The means for selecting a multichannel audio signal encoding dependent on the at least one parameter may comprise: means for selecting an initial default multichannel audio signal encoding; means for selecting a second audio signal multichannel audio signal encoding dependent on a first selection of the at least one parameter; and means for maintaining the second audio signal multichannel audio signal encoding dependent on a second selection of the at least one parameter.

The first selection of the at least one parameter may be a combination of a relative energy signal level and a correlation value associated with the at least two audio channels, and wherein the means for selecting the second audio signal multichannel audio signal encoding dependent on a first selection of the at least one parameter may comprise means for selecting the second audio signal multichannel audio signal encoding where the combination is greater than a determined threshold value.

The second selection of the at least one parameter may be a relative energy signal level associated with the at least two audio channels, and wherein the means for maintaining the second audio signal multichannel audio signal encoding may comprise means for maintaining the second audio signal multichannel audio signal encoding where the relative energy signal level is less than a second determined threshold value.

The multichannel audio signal encoding may comprise at least one of: binaural encoding; and near-far stereo encoding.

The means for encoding the audio signal with the multichannel audio signal encoding may comprise: means for combining the at least two audio channels to form a single combined channel audio signal; means for encoding the single combined channel audio signal; and means for generating data associated with the at least two audio channels using the multichannel audio signal encoding such that the data enables the at least two audio channels to be reproduced from the single combined channel audio signal.

According to a tenth aspect there is provided an apparatus comprising: means for receiving an encoded audio signal; means for selecting a multichannel audio signal decoding dependent on a first part of the encoded audio signal; and means for decoding a second part of the encoded audio signal, the second part of the audio signal encoded with a multichannel audio signal encoding, such that the decoding the second part of the encoded audio signal generates an audio signal comprising at least two audio channels.

The means for decoding a second part of the encoded audio signal may comprise: means for generating a first channel audio signal from a first section of the second part of the encoded audio signal; and means for generating at least one further channel audio signal from a second section of the second part of the encoded audio signal dependent on the multichannel audio signal decoding indicated by the first part of the encoded audio signal.

The first channel may be a left channel audio signal and the at least one further channel audio signal may be a right channel audio signal.

The first channel may be a combined channel audio signal and the at least one further channel audio signal may comprise a left channel signal and a right channel audio signal.

According to an eleventh aspect there is provided an apparatus comprising: means for determining at least one channel pair distance value for an audio signal comprising at least a pair of audio channels; means for encoding the audio signal with a multichannel audio signal encoding to generate at least an encoded signal and difference signal; and means for generating an equivalent difference signal dependent on the difference signal, the at least one channel pair distance value and an encoded channel distance value.

The apparatus may further comprise means for receiving the encoded channel distance value.

The means for receiving the encoded channel distance value may comprise at least one of: means for determining an encoded channel distance value from a user input; and means for receiving an encoded channel distance value from a decoder.

The apparatus may comprise means for receiving the audio signal from a pair of microphones, wherein a first audio channel may be from a first microphone and a second audio channel may be from a second microphone, wherein the means for determining the at least one channel pair distance value may comprise means for determining the distance between the first microphone and the second microphone.

According to a twelfth aspect there is provided an apparatus comprising: means for receiving an encoded signal and an equivalent difference signal; and means for reproducing a pair of audio channels with a determined channel distance dependent on the encoded signal and the equivalent difference signal.

The apparatus may comprise: means for determining an encoded channel distance value; and generating a pair of audio channels with a desired channel distance dependent on the encoded signal, the equivalent difference signal, the encoded channel distance value and the desired channel distance.

According to a thirteenth aspect there is provided an apparatus comprising: a channel analyser configured to analyse an audio signal comprising at least two audio channels to determine at least one parameter associated with a difference between the at least two audio channels; an encoding mode determiner configured to select a multichannel audio signal encoding dependent on the at least one parameter; and a channel encoder configured to encode the audio signal with the multichannel audio signal encoding.

The channel analyser may comprise: a time to frequency domain converter configured to generate a frequency domain representation for the at least two audio channels of the audio signal; a filter configured to separate the frequency domain representation for the at least two audio channels of the audio signal into at least two frequency bands; and a parameter determiner configured to generate at least one parameter associated with the difference between two audio channels for a frequency band.

The parameter determiner may comprise at least one of: a relative energy signal level determiner configured to determine a relative energy signal level associated with the at least two audio channels; a correlation determiner configured to determine a correlation value associated with the at least two audio channels; and a shift determiner configured to determine a time shift value associated with the at least two audio channels.

The encoding mode determiner may be configured to: select an initial default multichannel audio signal encoding; select a second audio signal multichannel audio signal encoding dependent on a first selection of the at least one parameter; and maintain the second audio signal multichannel audio signal encoding dependent on a second selection of the at least one parameter.

The first selection of the at least one parameter may be a combination of a relative energy signal level and a correlation value associated with the at least two audio channels, and wherein the encoding mode determiner may be configured to select the second audio signal multichannel audio signal encoding where the combination is greater than a determined threshold value.

The second selection of the at least one parameter may be a relative energy signal level associated with the at least two audio channels, and wherein the encoding mode determiner may be configured to maintain the second audio signal multichannel audio signal encoding where the relative energy signal level is less than a second determined threshold value.

The multichannel audio signal encoding may comprise at least one of: binaural encoding; and near-far stereo encoding.

The channel encoder may comprise: a mono channel generator configured to combine the at least two audio channels to form a single combined channel audio signal; a mono channel encoder configured to encode the single combined channel audio signal; and a further channel encoder configured to generate data associated with the at least two audio channels using the multichannel audio signal encoding such that the data enables the at least two audio channels to be reproduced from the single combined channel audio signal.

According to a fourteenth aspect there is provided an apparatus comprising: an input configured to receive an encoded audio signal; a multichannel decoding determiner configured to select a multichannel audio signal decoding mode dependent on a first part of the encoded audio signal; and a multichannel decoder configured to decode a second part of the encoded audio signal, the second part of the audio signal encoded with a multichannel audio signal encoding, such that the decoding the second part of the encoded audio signal generates an audio signal comprising at least two audio channels.

The multichannel decoder may comprise: a mono channel generator configured to generate a first channel audio signal from a first section of the second part of the encoded audio signal; and a stereo channel generator configured to generate at least one further channel audio signal from a second section of the second part of the encoded audio signal dependent on the multichannel audio signal decoding indicated by the first part of the encoded audio signal.

The first channel may be a left channel audio signal and the at least one further channel audio signal may be a right channel audio signal.

The first channel may be a combined channel audio signal and the at least one further channel audio signal may comprise a left channel signal and a right channel audio signal.

According to a fifteenth aspect there is provided an apparatus comprising: a channel distance determiner configured to determine at least one channel pair distance value for an audio signal comprising at least a pair of audio channels; a multichannel encoder configured to encode the audio signal with a multichannel audio signal encoding to generate at least an encoded signal and difference signal; and an equiviliser configured to generate an equivalent difference signal dependent on the difference signal, the at least one channel pair distance value and an encoded channel distance value.

The apparatus may further comprise an input configured to receive the encoded channel distance value.

The input may comprise at least one of: a user input configured to determine an encoded channel distance value; and a codec handshake input configured to receive an encoded channel distance value from a decoder.

The apparatus may comprise an input configured to receive the audio signal from a pair of microphones, wherein a first audio channel may be from a first microphone and a second audio channel may be from a second microphone, wherein the channel distance determiner may comprise a microphone distance determiner configured to determine the distance between the first microphone and the second microphone.

According to a sixteenth aspect there is provided an apparatus comprising: an input configured to receive an encoded signal and an equivalent difference signal; and a channel distance decoder configured to reproduce a pair of audio channels with a determined channel distance dependent on the encoded signal and the equivalent difference signal.

The apparatus may comprise: an encoded channel distance value determiner configured to determine an encoded channel distance value; and a audio channel generator configured to generate a pair of audio channels with a desired channel distance dependent on the encoded signal, the equivalent difference signal, the encoded channel distance value and the desired channel distance.

A computer program product may cause an apparatus to perform the method as described herein.

An electronic device may comprise apparatus as described herein.

A chipset may comprise apparatus as described herein.

### BRIEF DESCRIPTION OF DRAWINGS

For better understanding of the present invention, reference will now be made by way of example to the accompanying drawings in which:

FIG. 1 shows schematically an electronic device employing some embodiments;

FIG. 2 shows schematically an audio codec system according to some embodiments;

FIG. 3 shows schematically an encoder as shown in FIG. 2 according to some embodiments;

FIG. 4 shows schematically a channel analyser as shown in FIG. 3 in further detail according to some embodiments;

FIG. 5 shows schematically the channel encoder as shown in FIG. 3 in further detail according to some embodiments;

FIG. 6 shows a flow diagram illustrating the operation of the encoder shown in FIG. 2 according to some embodiments;

FIG. 7 shows a flow diagram illustrating the operation of the channel analyser as shown in FIG. 4 according to some embodiments;

FIG. 8 shows a flow diagram illustrating the operation of the channel encoder as shown in FIG. 5 according to some embodiments;

FIG. 9 shows schematically the decoder as shown in FIG. 2 according to some embodiments;

FIG. 10 shows a flow diagram illustrating the operation of the decoder as shown in FIG. 9 according to some embodiments;

FIGS. 11 and 12 show example mode selection results when using embodiments as described herein;

FIG. 13 shows time differences for sounds from varying angles for two microphones with various distances between them.

### DESCRIPTION OF SOME EMBODIMENTS OF THE APPLICATION

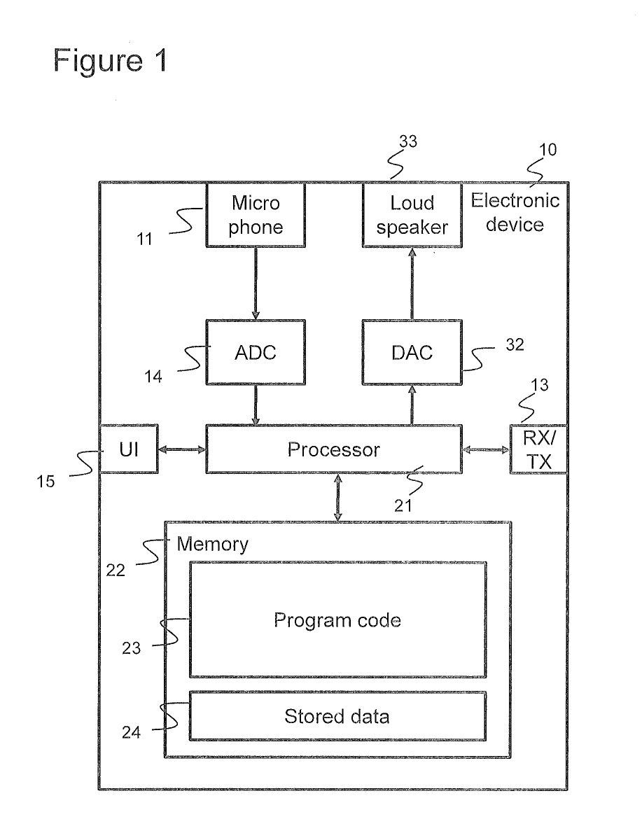

The following describes in more detail possible stereo speech and audio codecs, including layered or scalable variable rate speech and audio codecs. In this regard reference is first made to FIG. 1 which shows a schematic block diagram of an exemplary electronic device or apparatus 10, which may incorporate a codec according to an embodiment of the application.

The apparatus 10 may for example be a mobile terminal or user equipment of a wireless communication system. In other embodiments the apparatus 10 may be an audio-video device such as video camera, a Television (TV) receiver, audio recorder or audio player such as a mp3 recorder/player, a media recorder (also known as a mp4 recorder/player), or any computer suitable for the processing of audio signals.

The electronic device or apparatus 10 in some embodiments comprises a microphone 11, which is linked via an analogue-to-digital converter (ADC) 14 to a processor 21. The processor 21 is further linked via a digital-to-analogue (DAC) converter 32 to loudspeakers 33. The processor 21 is further linked to a transceiver (RX/TX) 13, to a user interface (UI) 15 and to a memory 22.

The processor 21 can in some embodiments be configured to execute various program codes. The implemented program codes in some embodiments comprise a multichannel or stereo encoding or decoding code as described herein. The implemented program codes 23 can in some embodiments be stored for example in the memory 22 for retrieval by the processor 21 whenever needed. The memory 22 could further provide a section 24 for storing data, for example data that has been encoded in accordance with the application.

The encoding and decoding code in embodiments can be implemented in hardware and/or firmware.

The user interface 15 enables a user to input commands to the electronic device 10, for example via a keypad, and/or to obtain information from the electronic device 10, for example via a display. In some embodiments a touch screen may provide both input and output functions for the user interface. The apparatus 10 in some embodiments comprises a transceiver 13 suitable for enabling communication with other apparatus, for example via a wireless communication network.

It is to be understood again that the structure of the apparatus 10 could be supplemented and varied in many ways.

A user of the apparatus 10 for example can use the microphone 11 for inputting speech or other audio signals that are to be transmitted to some other apparatus or that are to be stored in the data section 24 of the memory 22. A corresponding application in some embodiments can be activated to this end by the user via the user interface 15. This application in these embodiments can be performed by the processor 21, causes the processor 21 to execute the encoding code stored in the memory 22.

The analogue-to-digital converter (ADC) 14 in some embodiments converts the input analogue audio signal into a digital audio signal and provides the digital audio signal to the processor 21. In some embodiments the microphone 11 can comprise an integrated microphone and ADC function and provide digital audio signals directly to the processor for processing.

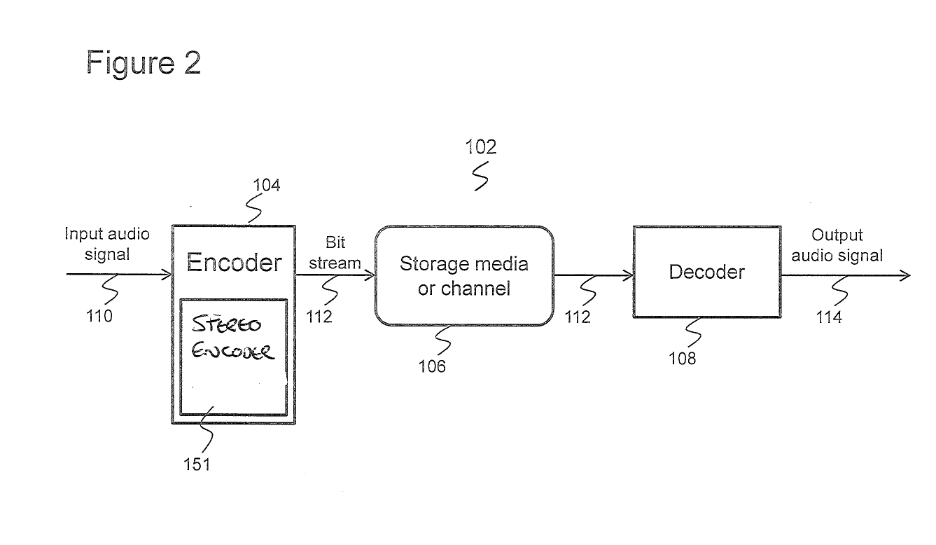

The processor 21 in such embodiments then processes the digital audio signal in the same way as described with reference to FIGS. 2 to 10.

The resulting bit stream can in some embodiments be provided to the transceiver 13 for transmission to another apparatus. Alternatively, the coded audio data in some embodiments can be stored in the data section 24 of the memory 22, for instance for a later transmission or for a later presentation by the same apparatus 10.

The apparatus 10 in some embodiments can also receive a bit stream with correspondingly encoded data from another apparatus via the transceiver 13. In this example, the processor 21 may execute the decoding program code stored in the memory 22. The processor 21 in such embodiments decodes the received data, and provides the decoded data to a digital-to-analogue converter 32. The digital-to-analogue converter 32 converts the digital decoded data into analogue audio data and can in some embodiments output the analogue audio via the loudspeakers 33. Execution of the decoding program code in some embodiments can be triggered as well by an application called by the user via the user interface 15.

The received encoded data in some embodiment can also be stored instead of an immediate presentation via the loudspeakers 33 in the data section 24 of the memory 22, for instance for later decoding and presentation or decoding and forwarding to still another apparatus.

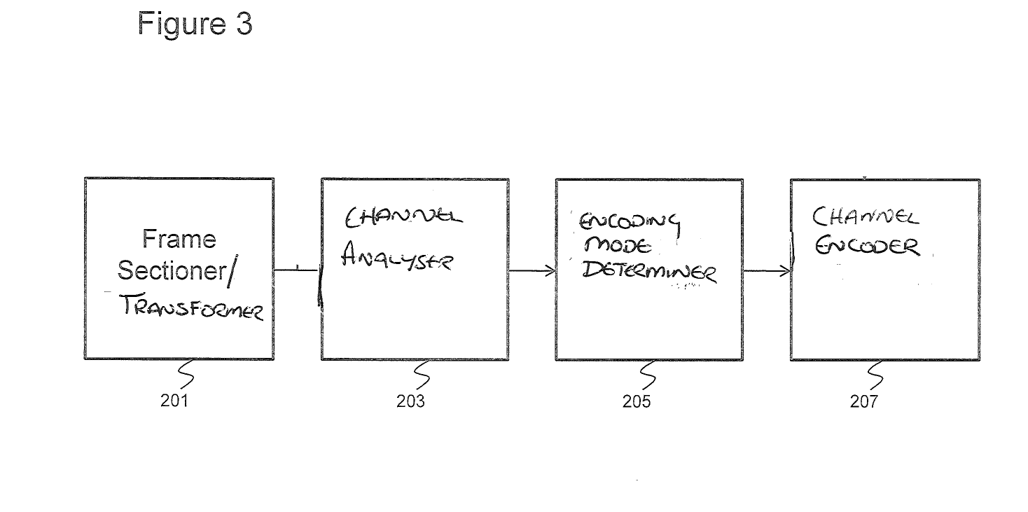

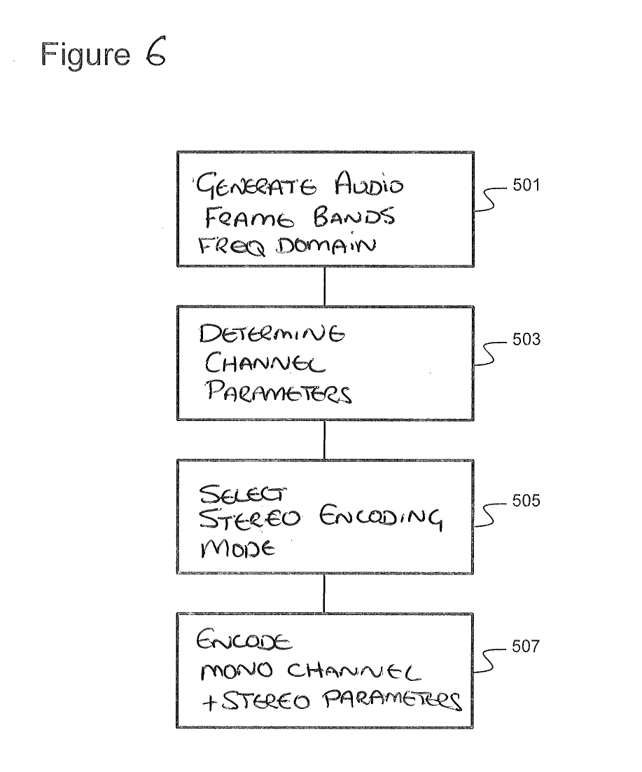

It would be appreciated that the schematic structures described in FIGS. 3 to 5 and 9, and the method steps shown in FIGS. 6 to 8 and 10 represent only a part of the operation of an audio codec and specifically part of a stereo encoder/decoder apparatus or method as exemplarily shown implemented in the apparatus shown in FIG. 1.

The general operation of audio codecs as employed by embodiments is shown in FIG. 2. General audio coding/decoding systems comprise both an encoder and a decoder, as illustrated schematically in FIG. 2. However, it would be understood that some embodiments can implement one of either the encoder or decoder, or both the encoder and decoder. Illustrated by FIG. 2 is a system 102 with an encoder 104 and in particular a stereo encoder 151, a storage or media channel 106 and a decoder 108. It would be understood that as described above some embodiments can comprise or implement one of the encoder 104 or decoder 108 or both the encoder 104 and decoder 108.

The encoder 104 compresses an input audio signal 110 producing a bit stream 112, which in some embodiments can be stored or transmitted through a media channel 106. The encoder 104 furthermore can comprise a stereo encoder 151 as part of the overall encoding operation. It is to be understood that the stereo encoder may be part of the overall encoder 104 or a separate encoding module. The encoder 104 can also comprise a multi-channel encoder that encodes more than two audio signals.

The bit stream 112 can be received within the decoder 108. The decoder 108 decompresses the bit stream 112 and produces an output audio signal 114. The decoder 108 can comprise a stereo decoder as part of the overall decoding operation. It is to be understood that the stereo decoder may be part of the overall decoder 108 or a separate decoding module. The decoder 108 can also comprise a multi-channel decoder that decodes more than two audio signals. The bit rate of the bit stream 112 and the quality of the output audio signal 114 in relation to the input signal 110 are the main features which define the performance of the coding system 102.

FIG. 3 shows schematically the encoder 104 according to some embodiments.

FIG. 6 shows schematically in a flow diagram the operation of the encoder 104 according to some embodiments.

The concept for the embodiments as described herein is to determine and apply a stereo coding mode to produce efficient high quality and low bit rate real life stereo signal coding. To that respect with respect to FIG. 3 an example encoder 104 is shown according to some embodiments. Furthermore with respect to FIG. 6 the operation of the encoder 104 is shown in further detail.

The encoder 104 in some embodiments comprises a frame sectioner/transformer 201. The frame sectioner/transformer 201 is configured to receive the left and right (or more generally any multichannel audio representation) input audio signals and generate frequency domain representations of these audio signals to be analysed and encoded. These frequency domain representations can be passed to the channel parameter determiner 203.

In some embodiments the frame sectioner/transformer can be configured to section or segment the audio signal data into sections or frames suitable for frequency domain transformation. The frame sectioner/transformer 201 in some embodiments can further be configured to window these frames or sections of audio signal data according to any suitable windowing function. For example the frame sectioner/transformer 201 can be configured to generate frames of 20 ms which overlap preceding and succeeding frames by 10 ms each.

In some embodiments the frame sectioner/transformer can be configured to perform any suitable time to frequency domain transformation on the audio signal data. For example the time to frequency domain transformation can be a discrete Fourier transform (DFT), Fast Fourier transform (FFT), modified discrete cosine transform (MDCT). In the following examples a Fast Fourier Transform (FFT) is used. Furthermore the output of the time to frequency domain transformer can be further processed to generate separate frequency band domain representations of each input channel audio signal data. These bands can be arranged in any suitable manner. For example these bands can be linearly spaced, or be perceptual or psychoacoustically allocated.

The operation of generating audio frame band frequency domain representations is shown in FIG. 6 by step 501.

In some embodiments the frequency domain representations are passed to a channel analyser.

In some embodiments the encoder comprises a channel analyser 203. The channel analyser 203 can be configured to analyse the frequency domain audio signals and determine parameters associated with each band of each channel and output these parameter values to an encoding mode determiner 205.

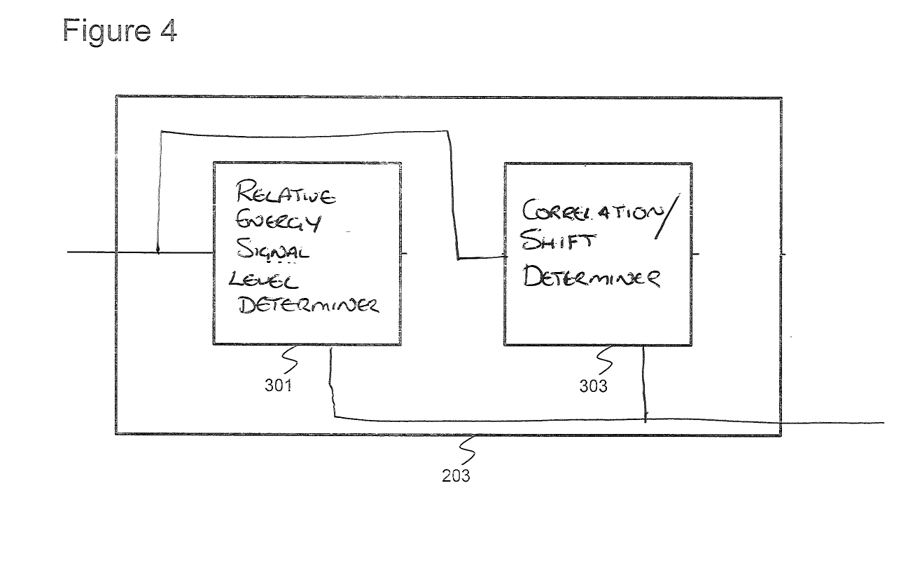

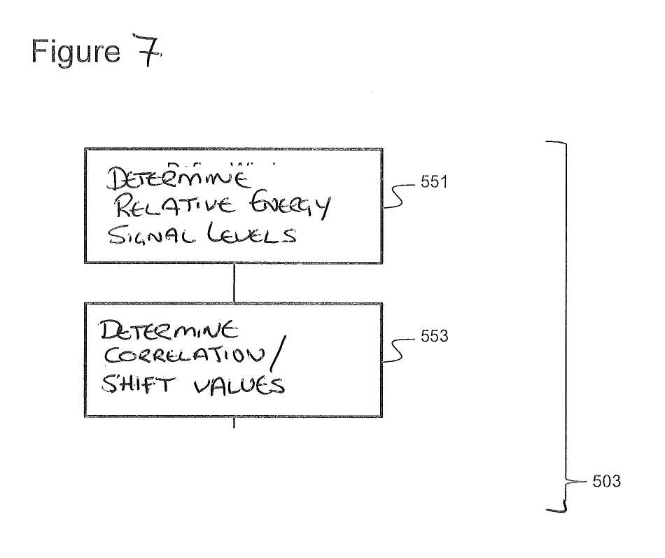

With respect to FIG. 4 an example channel analyser 203 according to some embodiments is described in further detail. Furthermore with respect to FIG. 7 the operation of the channel analyser 203 according to some embodiments as shown in FIG. 4 is shown.

In some embodiments the channel analyser 203 comprises a relative energy signal level determiner 301. The relative energy signal level determiner 301 is configured to receive the output frequency domain representations and determine the relative signal levels between pairs of channels for each band. It would be understood that in the following examples a single pair of channels are analysed and processed however this can be extended to any number of channels by a suitable pairing of the multichannel system.

In some embodiments the relative level for each band can be computing using the following code.

For (j = 0; j < NUM_OF_BANDS_FOR_SIGNAL_LEVELS; j++)

{

mag_l = 0.0;
mag_r = 0.0;
for (k = BAND_START[j]; k < BAND_START[j+1]; k++)
{

mag_l += fft_l[k]*fft_l[k] +
fft_l[L_FFT−k]*fft_l[L_FFT−k];
mag_r += fft_r[k]*fft_r[k] +
fft_r[L_FFT−k]*fft_r[L_FFT−k];

}
mag[j] =
10.0f*log10(sqrt((mag_l+EPSILON)/(mag_r+EPSILON)));

}

Where L_FFT is the length of the FFT and EPSILON is a small value above zero to prevent division by zero problems. The relative energy signal level determiner in such embodiments effectively generates magnitude determinations for each channel (L and R) over each band and then divides one channel value by the other to generate a relative value. In some embodiments the relative energy signal level determiner 301 is configured to output the relative energy signal level to the encoding mode determiner 205.

The operation of determining the relative energy signal level is shown in FIG. 7 by step 551.

In some embodiments the channel analyser 203 comprises a correlation/shift determiner 303. The correlation/shift determiner 303 is configured to determine the correlation or shift per band between the two channels (or parts of multi-channel audio signals). The shifts (or the best correlation indices COR_IND[j]) can be determined for example using the following code.

for ( j = 0; NUM_OF_BANDS_FOR_COR_SEARCH; j++ )
{

cor = COR_INIT;
for ( n = 0; n < 2*MAXSHIFT + 1; n++ )
{

mag[n] = 0.0f;
for ( k = COR_BAND_START[j]; k <
COR_BAND_START[j+1]; k++ )
{

mag[n] += svec_re[k] * cos( −2*PI*((n−MAXSHIFT) *
k / L_FFT );
mag[n] −= svec_im[k] * sin( −2*PI*((n−MAXSHIFT) *
k / L_FFT );

}
if (mag[n] > cor)
{

cor_ind[j] = n − MAXSHIFT;
cor = mag[n];

}

}

}

Where the value MAXSHIFT is the largest allowed shift (the value can be based on a model of the supported microphone arrangements or more simply the distance between the microphones) PI is π, COR_INIT is the initial correlation value or a large negative value to initialise the correlation calculation, and COR_BAND_START [ ] defines the starting points of the sub-bands. The vectors svec_re [ ] and svec_im [ ], the real and imaginary values for the vector, used herein are defined as follows:

svec_re[0] = fft_l[0] * fft_r[0];
svec_im[0] = 0.0f;
for (k = 1; k <
COR_BAND_START[NUM_OF_BANDS_FOR_COR_SEARCH];
k++)
{

svec_re[k] = (fft_l[k] * fft_r[k])−(fft_l[L_FFT−k] *
(−fft_r[L_FFT−k]));
svec_im[k] = (fft_l[L_FFT−k] * fft_r[k]) + (fft_l[k] *
(−fft_r[L_FFT−k]));

}

The operation of determining the correlation/shift values is shown in FIG. 7 by step 553.

In some embodiments the encoder comprises an encoding mode determiner 205. The encoding mode determiner 205 is configured to receive the channel analyser values and based on these values control the channel encoder 207 to use a specific encoding mode.

In some embodiments the encoding mode determiner 205 can be configured with a default encoding mode to encode. For example the encoding mode determiner can be configured to default to controlling the encoder stereo or multichannel signals as a binaural stereo coding. In some embodiments the encoding mode determiner can control the encoder according to two rules. The first rule or determination step is determining when the coding should change from the back up or default mode (of binaural coding) to the other mode of coding (the near-far stereo coding) and the second rule or determination step of determining where to maintain the other coding mode (the near-far coding mode.

In some embodiments the target of these two determination steps is to make sure that the switching to the other mode (the near-far configuration) only happens when it is useful, for example the mode selection can switch and maintain the near-far mode for a speech burst.

In some embodiments the encoding mode determination can be performed using the signal of length L_SIGNAL according to the following:

temp_enter = 0;
tmpmag = 0.0;
tmpind = 0.0;
for k = 1 : L_SIGNAL

if k <= MEMORY_LEN

tmpmag = tmpmag + abs(mag_sum(1,k));
tmpind = tmpind + abs(ind_sum(1,k));

```
else
  tmpmag = tmpmag + abs(mag_sum(1,k)) − abs(mag_sum(1,k−MEMORY_LEN));
  tmpind = tmpind + abs(ind_sum(1,k)) − abs(ind_sum(1,k−MEMORY_LEN));
end
if tmp_enter < ENTER_COUNT
```

if abs(mag_sum(1,k)).*ind_sum(1,k) > MODE_TH_CMB_ENTER1 && ...

abs(tmpmag/MEMORY_LEN).*ind_sum(1,k) > MODE_TH_CMB_ENTER2

tmp_enter = tmp_enter + 1;

else

tmp_enter = 0;

end

elseif abs(tmpmag/MEMORY_LEN) > MODE_TH_MAG_STAY

mode(1,k) = 1;
tmp_count = PROPER_COUNT;

elseif abs(tmpmag/MEMORY_LEN) > ...

(1−(1/PROPER_COUNT)*tmp_count)*MODE_TH_MAG_STAY

mode(1,k) = 1;
tmp_count = tmp_count − 1;

else

tmp_enter = 0;

end

end

where the value MODE is the output mode selection vector. In other words the indication passed to the channel encoder to control whether the channels are encoded one way (the binaural coding) or another (the near-far encoding). In this example a selection vector of 0 is binaural and 1 is near-far stereo. The values mag_sum and ind_sum represents sums over the magnitudes and correlation indices from the channel analyser, the value MEMORY_LEN defines the length of the memory used for calculating past averages for the temporary magnitude values, the value ENTER_COUNT defines how quickly the switch can be made from binaural to near far stereo when potential near far frames are detected in other words the first rule value, the value, MODE_TH_CMB_ENTER1, MODE_TH_CMB_ENTER2 (where the former value enter 1 is larger than latter value enter 2), and MODE_TH_MAG_STAY defines threshold values for the mode section parameters once entering near-far stereo coding to maintain it the coding mode. In other words the second rule determination value. Furthermore the value PROPER_COUNT defines the number of frames since the last frame which was considered as a suitable near-far stereo frame coding candidate.

In the examples discussed herein the embodiments do not use a look ahead however in some embodiments the look ahead information can also be used where available to determine the coding mode. In some embodiments the first rule (the change from the default or binaural coding node to the other or near-far mode) can be determined based on a combination of relative magnitude values and shift values while the second rule, that of maintaining the other mode (the near-far stereo encoding mode) can be determined using the relative magnitude parameters only. In some embodiments any suitable combination of parameters can be used for judging whether to maintain other mode (the near-far coding mode) or switch back to the default mode (binaural coding). In some embodiments the threshold values can be variable and be subject to long term adaptation to improve the robustness of the mode determination or selection. For example the channels in near-far stereo mode are likely to remain static (in other words the left channel is likely to always be the near channel and the right channel is likely to be always the far channel or vice versa).

In the example described herein the bands are summed equally however it would be understood that a psycho-acoustic weighting function could be implemented to improve the performance where in such embodiments some bands are weighted relative to other bands.

In some embodiments the encoding mode determiner 205 can be configured to receive further inputs. For example in some embodiments the mode determination can be overridden or forced where the input is known. For example in some embodiments a command line or user selection option can be used to determine the encoding mode to be used. Furthermore in some embodiments the mode can be overridden based on some externally received signalling or indication. For example in some embodiments the encoding mode can be determined where the device indicates it is operating in a near-far mode and the microphone of the device near the earpiece is connected to the right channel and the main microphone is connected to the left channel.

The operation of selecting the stereo encoding mode is shown in FIG. 6 by step 505.

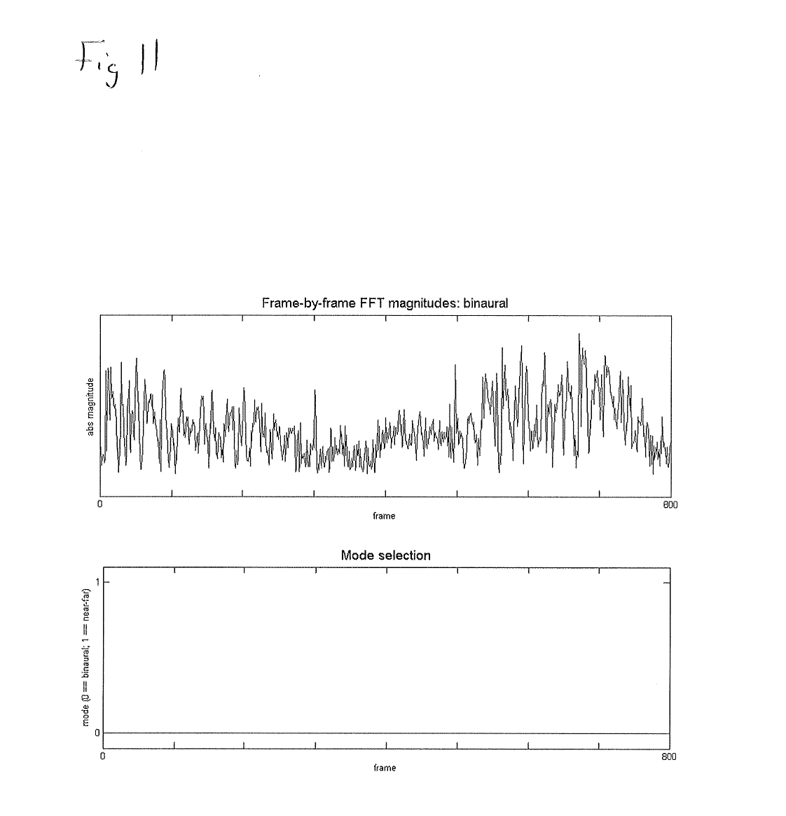

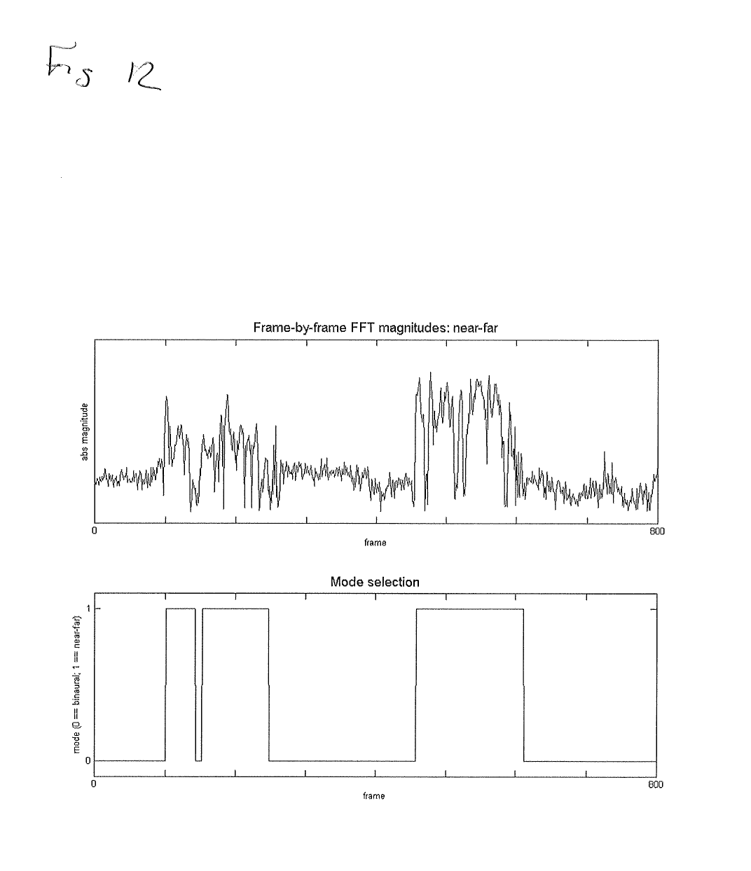

As shown in FIGS. 11 and 12 a substantially binaural captured signal and audio signal with near-far data is shown with the associated mode selection/determination output according to some embodiments.

In some embodiments the encoder comprises a channel encoder 207. The channel encoder is configured to receive the audio signal data and the encoding mode determiner output to encode the audio signals in a determined multichannel mode.

The operation of encoding the mono channel and stereo parameters is shown in FIG. 6 by step 507.

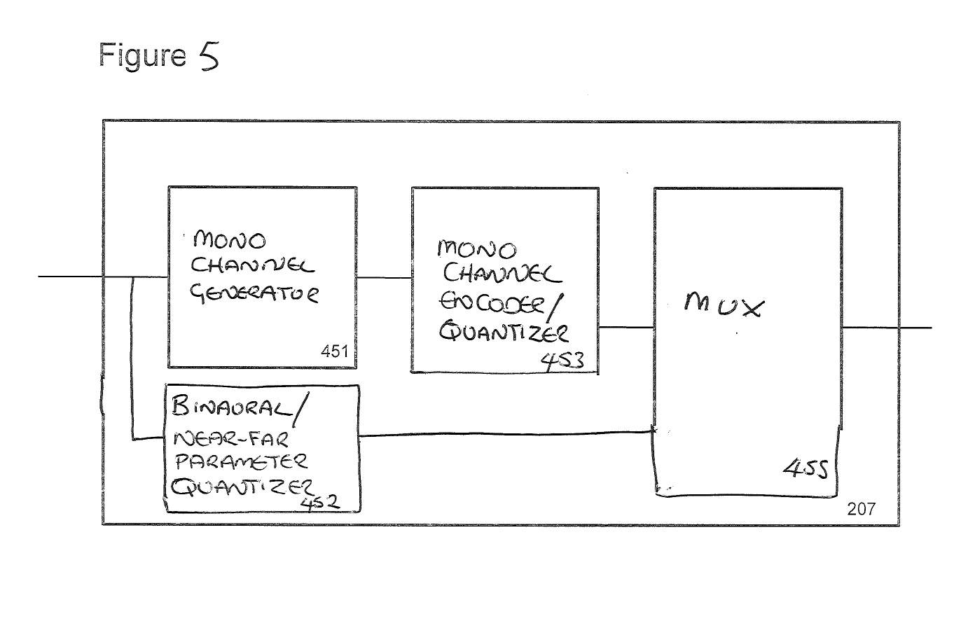

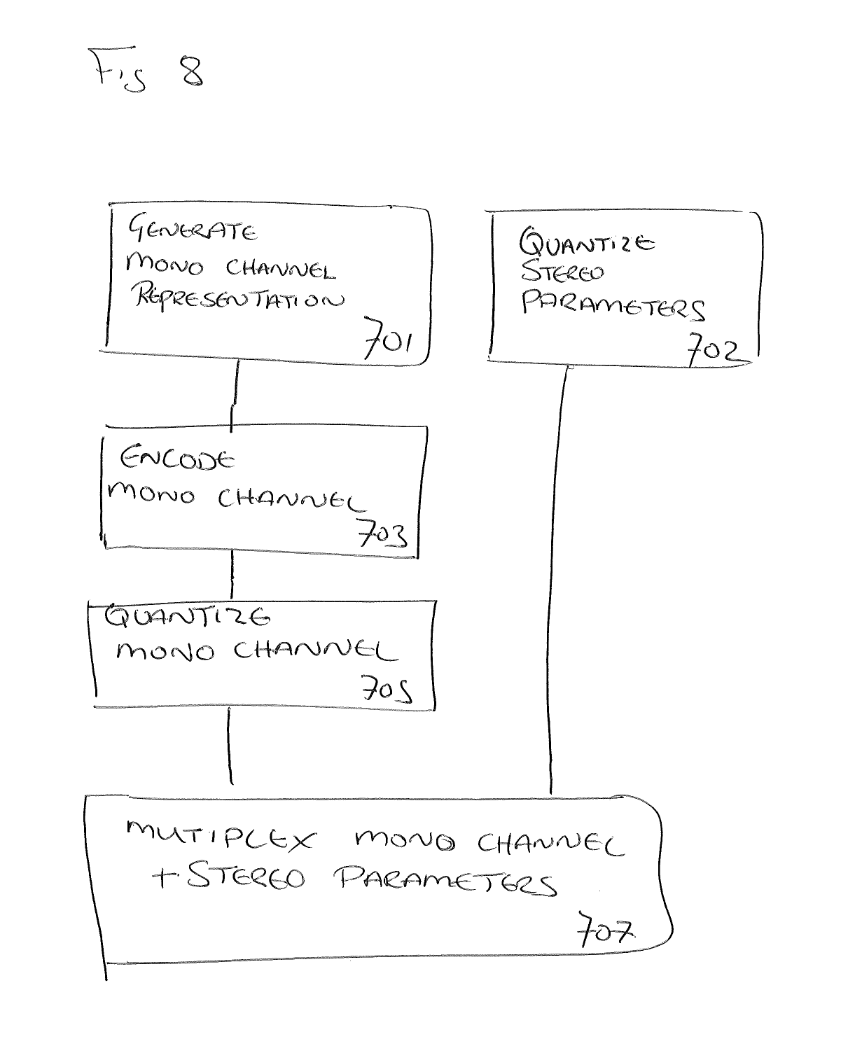

With respect to FIG. 5 the channel encoder according to some embodiments is shown in further detail. Furthermore with respect to FIG. 8 the operation of the channel encoder 207 is described in further detail.

In some embodiments the channel encoder 207 comprises a mono channel generator 451. The mono channel generator 451 is configured to receive the audio signal frequency domain representations for at least a pair of the audio channels and generate a mono audio channel from these multichannel audio signals. In some embodiments for example in a two channel (left and right channel) audio signal system the left and right channels are combined into a mono channel using the relative shift information from the channel analyser 203. In some embodiments the generation of the mono channel is selected from more than one method dependent on the encoding mode determination. For example the combination mode described herein can be used for binaural mode encoding and a separate mode wherein the dominant of the left or right channel audio signal is selected as the “near” channel of the two audio signals is selected for encoding when the encoding mode is the near-far mode.

The operation of generating the mono channel representation is shown in FIG. 8 by step 701.

The mono channel generator 451 can in some embodiments output the generated mono channel to a mono channel encoder/quantizer 453.

In some embodiments the encoder comprises a mono channel encoder/quantizer 453. The mono channel encoder/quantizer 453 can be configured to receive the mono channel generated by the mono channel generator 451 and encode the mono channel in any suitable format.

For example in some embodiments the mono signal encoding can be an EVS mono channel encoded form, which may contain a bit stream interoperable version of the AMR-WB codec. However any suitable encoding method can be implemented.

The operation of encoding the mono channel is shown in FIG. 8 by step 703.

The mono channel encoder/quantizer 453 can further be configured in some embodiments to quantize the mono channel representation.

The operation of quantizing the mono channel is shown in FIG. 8 by step 705.

The mono channel encoder/quantizer 453 output can in some embodiments be output to the multiplexer 455.

In some embodiments the encoder comprises a binaural/near far parameter quantizer 452. The binaural/near-far parameter quantizer 452 can be configured to receive the shifts and relative level values which define the amplitude and frequency/time shift relationships between the two channels and encode or quantize these in a form suitable for transmission.

In some embodiments the binaural/near far parameter quantizer 452, on receiving the encoding mode determiner output can be configured to encode the parameters in such a manner that the quantizer for the shifts and relative level values depend on the output of the encoding mode determiner 205. In some embodiments the stereo encoding mode determination indication is also enclosed or attached so it can be received/retrieved by the decoder.

In some embodiments the generation of the stereo binaural signals from the mono channel and the quantized shift and relative values can be made dependent on further information from the codec. Thus for example as the shift values are quantized in the encoder in some embodiments the quantized shift value can be changed to reflect the distance between a “real” pair of ears (which is typically about 170 mm) and not the real distance between the microphones. Thus the quantization step can be configured such that the quantization values can be biased towards larger values in quantization when the distance between microphones is smaller than the distance between human ears.

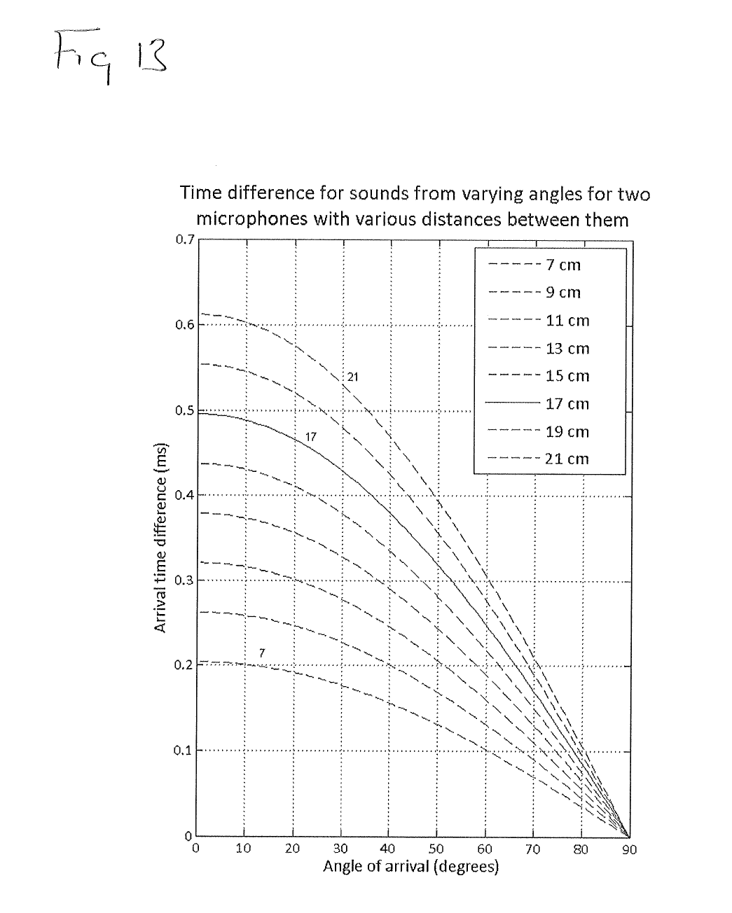

Thus for example as shown in FIG. 13 the effect of the distance between input microphones where 8 microphone distances are considered ranging from 7 cm to 21 cm where the distance of 17 cm represents the typical actual distance between human ears. In the graph of FIG. 13 an angle of zero degrees represents the sound coming directly from the right or left, while the angle of 90 degrees represents a sound coming from directly in front. When in such embodiments the decoder renders the audio signals for headphone listening the decoder uses the quantized shift values. For example a sound coming directly to the side zero degrees with a microphone distance of 7 cm could be perceived as coming from an angle of about 60 degrees (which is more to the front or back than the side). This would clearly not provide an optimal spatial quality. Similarly with a microphone distance of 21 cm a sound coming from the angle of 40 degrees could be perceived as coming from almost the side (perhaps about 20 degrees). In some embodiments the binaural/near-far parameter quantizer 452 can be configured to generate a predetermined distance equivalent value, such as a 17 cm distance equivalent value, having determined or estimated the capture microphone separation distance and then quantize the predetermined distance equivalent value. In some embodiments as the shift determination and quantizing is performed band by band then the conversion to a distance “equivilization” can also be performed band by band. In some embodiments the “equivilization” is performed by a look-up table of values, with the current shift and microphone distance values as inputs.

In some embodiments the targeted distance equivalent value can be given as an input to the algorithm. In some embodiments this value may for example be negotiated between two communication devices at the start of the communication session.

The operation of quantizing the stereo parameters is shown in FIG. 8 by step 702.

Furthermore in some embodiments the encoder 455 comprises a multiplexer configured to multiplex the encoded mono channel and the stereo quantized values and to generate a single output data stream.

The operation of multiplexing the mono channel and stereo parameters is shown in FIG. 8 by step 707.

The operation of encoding the mono channel and stereo parameters is shown in FIG. 6 by step 507.

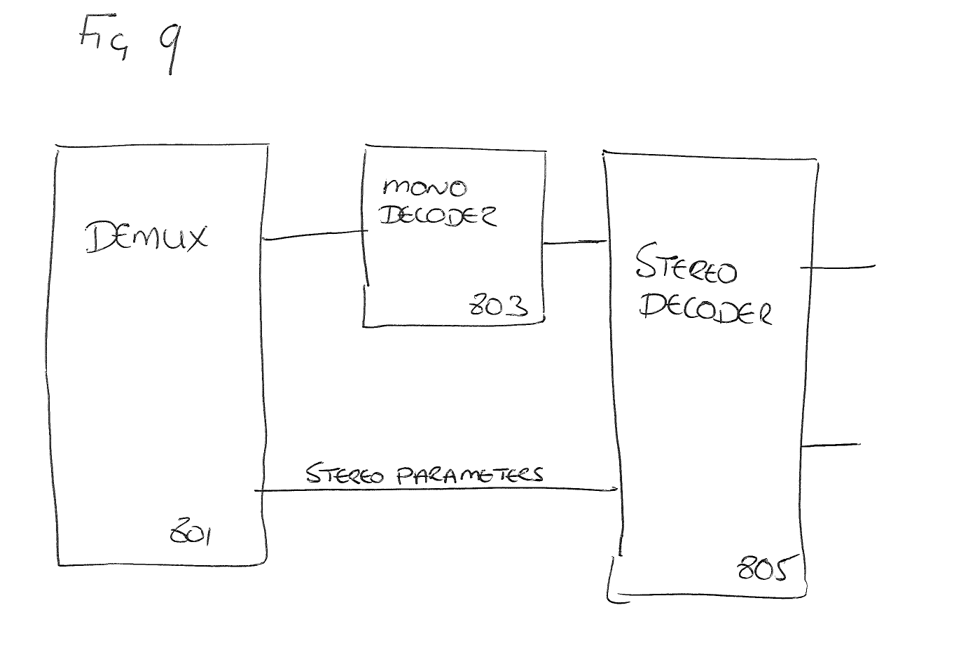

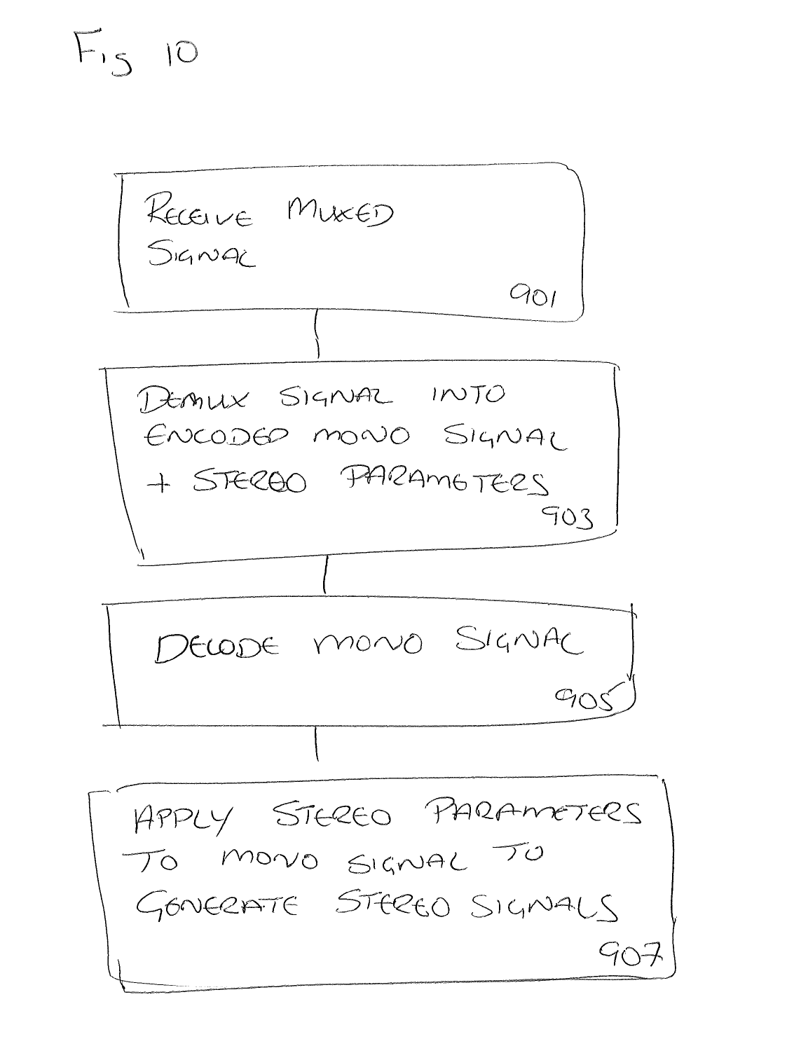

In order to fully show the operations of the codec with respect to some embodiments, with respect to FIGS. 9 and 10 a decoder and the operation of a decoder are shown.

In some embodiments the decoder comprises a de-multiplexer 801. The de-multiplexer 801 is configured to receive the multiplexed signal and to de-multiplex the signal into encoded mono signal and stereo parameters.

The operation of receiving the multiplexed signal is shown in FIG. 10 by step 901.

Furthermore the operation of de-multiplexing the signal into encoded mono signal and stereo parameters is shown in FIG. 10 by step 903.

The de-multiplexer can in some embodiments be configured to output the mono signal to a mono decoder and the stereo parameters to the stereo decoder.

In some embodiments the decoder comprises a mono decoder 803. The mono decoder 803 can be configured to perform the inverse or reciprocal arrangement to the mono channel encoder 453 shown in FIG. 5.

The operation of decoding the mono signal is shown in FIG. 10 by step 905.

The mono decoder 803 can be configured to output the decoded mono channel to the stereo decoder 805. In some embodiments the decoder comprises a stereo decoder 205.

The stereo decoder 805 is configured in some embodiments to receive the mono decoded signal and the stereo parameters and generate or reconstruct the separate a left and right channel audio signal dependent on the stereo parameters. Thus for example in some embodiments each stereo decoder 805 is configured to operate as a binaural decoder where the stereo parameters determine that the encoding was performed a binaural encoding and a near far decoder when the encoding mode was determined as near-far encoding. Thus binaural de-correlation of the signals can be formed to improve the perceptual effect of hearing the signals from outside of one's head in binaural headphone listening.

The operation of applying the stereo parameters to the mono signal to generate stereo signals is shown in FIG. 10 by step 907.

Although the above examples describe embodiments of the application operating within a codec within an apparatus 10, it would be appreciated that the invention as described below may be implemented as part of any audio (or speech) codec, including any variable rate/adaptive rate audio (or speech) codec. Thus, for example, embodiments of the application may be implemented in an audio codec which may implement audio coding over fixed or wired communication paths.

Thus user equipment may comprise an audio codec such as those described in embodiments of the application above.

It shall be appreciated that the term user equipment is intended to cover any suitable type of wireless user equipment, such as mobile telephones, portable data processing devices or portable web browsers.

Furthermore elements of a public land mobile network (PLMN) may also comprise audio codecs as described above.

In general, the various embodiments of the application may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the application may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this application may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the application may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

As used in this application, the term ‘circuitry’ refers to all of the following:
(a) hardware-only circuit implementations (such as implementations in only analog and/or digital circuitry) and
(b) to combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone or server, to perform various functions and
(c) to circuits, such as a microprocessor(s) or a portion of a microprocessor(s), that require software or firmware for operation, even if the software or firmware is not physically present.

This definition of ‘circuitry’ applies to all uses of this term in this application, including any claims. As a further example, as used in this application, the term ‘circuitry’ would also cover an implementation of merely a processor (or multiple processors) or portion of a processor and its (or their) accompanying software and/or firmware. The term ‘circuitry’ would also cover, for example and if applicable to the particular claim element, a baseband integrated circuit or applications processor integrated circuit for a mobile phone or similar integrated circuit in server, a cellular network device, or other network device.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-45. (canceled)

46. A method comprising:
generating a frequency domain representation for the at least two audio channels of the audio signal;
separating the frequency domain representation for the at least two audio channels of the audio signal into at least two frequency bands;
generating at least one parameter associated with the difference between two audio channels for a frequency band;
selecting a multichannel audio signal encoding dependent on the at least one parameter; and
encoding the audio signal with the multichannel audio signal encoding.

47. The method as claimed in claim 46, wherein the parameter comprises at least one of:
a relative energy signal level associated with the at least two audio channels;
a correlation value associated with the at least two audio channels; and
a time shift value associated with the at least two audio channels.

48. The method as claimed in claim 46, wherein selecting a multichannel audio signal encoding dependent on the at least one parameter comprises:
selecting an initial default multichannel audio signal encoding;
selecting a second audio signal multichannel audio signal encoding dependent on a first selection of the at least one parameter; and
maintaining the second audio signal multichannel audio signal encoding dependent on a second selection of the at least one parameter.

49. The method as claimed in claim 48, wherein the first selection of the at least one parameter is a combination of a relative energy signal level and a correlation value associated with the at least two audio channels, and wherein selecting the second audio signal multichannel audio signal encoding dependent on a first selection of the at least one parameter comprises selecting the second audio signal multichannel audio signal encoding where the combination is greater than a determined threshold value.

50. The method as claimed in claim 48, wherein the second selection of the at least one parameter is a relative energy signal level associated with the at least two audio channels, and wherein maintaining the second audio signal multichannel audio signal encoding comprises maintaining the second audio signal multichannel audio signal encoding where the relative energy signal level is less than a second determined threshold value.

51. The method as claimed in claim 46, wherein the multichannel audio signal encoding comprises at least one of:
binaural encoding; and
near-far stereo encoding.

52. The method as claimed in claim 46, wherein encoding the audio signal with the multichannel audio signal encoding comprises:
combining the at least two audio channels to form a single combined channel audio signal;
encoding the single combined channel audio signal; and
generating data associated with the at least two audio channels using the multichannel audio signal encoding such that the data enables the at least two audio channels to be reproduced from the single combined channel audio signal.

53. A method comprising:
receiving an encoded audio signal;
selecting a multichannel audio signal decoding dependent on a first part of the encoded audio signal; and
decoding a second part of the encoded audio signal, the second part of the audio signal encoded with a multichannel audio signal encoding, wherein decoding a second part of the encoded audio signal comprises:
generating a first channel audio signal from a first section of the second part of the encoded audio signal; and
generating at least one further channel audio signal from a second section of the second part of the encoded audio signal dependent on the multichannel audio signal decoding indicated by the first part of the encoded audio signal.

54. The method as claimed in claim 53, wherein the first channel is a left channel audio signal and the at least one further channel audio signal is a right channel audio signal.

55. The method as claimed in claim 53, wherein the first channel is a combined channel audio signal and the at least one further channel audio signal comprises a left channel signal and a right channel audio signal.

56. An apparatus comprising at least one processor and at least one memory including computer program code for one or more programs, the at least one memory and the computer program code configured to, with the at least one processor, cause the apparatus at least to:
generate a frequency domain representation for the at least two audio channels of the audio signal;
separate the frequency domain representation for the at least two audio channels of the audio signal into at least two frequency bands;
generate at least one parameter associated with the difference between two audio channels for a frequency band;
select a multichannel audio signal encoding dependent on the at least one parameter; and
encode the audio signal with the multichannel audio signal encoding.

57. The apparatus as claimed in claim 56, wherein the parameter comprises at least one of:
a relative energy signal level associated with the at least two audio channels;
a correlation value associated with the at least two audio channels; and
a time shift value associated with the at least two audio channels.

58. The apparatus as claimed in claim 56, wherein the apparatus caused to select a multichannel audio signal encoding dependent on the at least one parameter is further caused to:
select an initial default multichannel audio signal encoding;
select a second audio signal multichannel audio signal encoding dependent on a first selection of the at least one parameter; and
maintain the second audio signal multichannel audio signal encoding dependent on a second selection of the at least one parameter.

59. The apparatus as claimed in claim 58, wherein the first selection of the at least one parameter is a combination of a relative energy signal level and a correlation value associated with the at least two audio channels, and wherein selecting the second audio signal multichannel audio signal encoding dependent on a first selection of the at least one parameter comprises selecting the second audio signal multichannel audio signal encoding where the combination is greater than a determined threshold value.

60. The apparatus as claimed in claim 58, wherein the second selection of the at least one parameter is a relative energy signal level associated with the at least two audio channels, and wherein maintaining the second audio signal multichannel audio signal encoding comprises maintaining the second audio signal multichannel audio signal encoding where the relative energy signal level is less than a second determined threshold value.

61. The apparatus as claimed in claim 56, wherein the multichannel audio signal encoding comprises at least one of:
binaural encoding; and
near-far stereo encoding.

62. The apparatus as claimed in claim 56, wherein the apparatus caused to encode the audio signal with the multichannel audio signal encoding is further caused to:
combine the at least two audio channels to form a single combined channel audio signal;
encode the single combined channel audio signal; and
generate data associated with the at least two audio channels using the multichannel audio signal encoding such that the data enables the at least two audio channels to be reproduced from the single combined channel audio signal.

63. An apparatus comprising at least one processor and at least one memory including computer program code for one or more programs, the at least one memory and the computer program code configured to, with the at least one processor, cause the apparatus at least to:
receive an encoded audio signal;
select a multichannel audio signal decoding dependent on a first part of the encoded audio signal; and
decode a second part of the encoded audio signal, the second part of the audio signal encoded with a multichannel audio signal encoding, wherein the apparatus caused to decode a second part of the encoded audio signal is further caused to:
generate a first channel audio signal from a first section of the second part of the encoded audio signal; and
generate at least one further channel audio signal from a second section of the second part of the encoded audio signal dependent on the multichannel audio signal decoding indicated by the first part of the encoded audio signal.

64. The apparatus as claimed in claim 63, wherein the first channel is a left channel audio signal and the at least one further channel audio signal is a right channel audio signal.

65. The apparatus as claimed in claim 63, wherein the first channel is a combined channel audio signal and the at least one further channel audio signal comprises a left channel signal and a right channel audio signal.
